(19) United States
(12) Patent Application Publication
(10) Pub. No.: US 2009/0311536 A1
(43) Pub. Date: Dec. 17, 2009

(54) Plastic Lens

(76) Inventors: Hiroshi Kojima, Tokyo (JP); Tsuyoshi Sakurazawa, Tokyo (JP); Minoru Itou, Tokyo (JP); Toshikazu Hashimoto, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/373,760

(22) PCT Filed: Jul. 13, 2007
(86) PCT No.: PCT/JP2007/064006

§ 371 Date: Aug. 10, 2009

(30) Foreign Application Priority Data
Jul. 14, 2006 (JP) 2006-193561
Jun. 29, 2007 (JP) 2007-173062

(51) Int. Cl. B32B 27/40; G02B 1/04

(52) U.S. Cl. 428/423.5; 428/447; 359/642

(57) ABSTRACT

A plastic lens is provided which is excellent in abrasion resistance, transparency and appearance, and the plastic lens contains, as a substrate, a lens containing a resin having an NHCO structure and a resin containing a specific monomer, and a cured film having an NHCO structure formed by reacting a coating composition directly on the substrate, the coating composition containing a component (i) that is at least one selected from a specific organosilicon compound and a hydrolysate thereof, a component (ii) that is at least one selected from an amino group-containing organic compound, a hydroxyl group-containing organic compound, a mercapto group-containing organic compound, an amino group-containing organosilicon compound, a hydroxyl group-containing organosilicon compound and a mercapto group-containing organosilicon compound, and a component (iii) that is at least one selected from an isocyanate group-containing organic compound and an isocyanate group-containing organosilicon compound.

### TECHNICAL FIELD

The present invention relates to a plastic lens, and in particular, relates to a plastic lens excellent in abrasion resistance, transparency, appearance and adhesion between a substrate and a cured film.

### BACKGROUND ART

A polythiourethane lens containing xylylene diisocyanate as a polyisocyanate compound and having a refractive index of about from 1.66 to 1.68 has been well known as it has good characteristics including a high refractive index, good processability and the like (Patent Document 1). A plastic lens obtained by reacting an epithio group-containing compound, such as bis(β-epithiopropyl)sulfide, bis(β-epithiopropyl)disulfide or the like, as a major component and having a refractive index of about 1.70 has also well known (Patent Document 2).

In the case where these plastic lens substrates are used as a lens for spectacles, a cured film, which is referred to as a hard coat, is generally applied thereto. Upon coating and curing the hard coat on the plastic lens substrates, such a plastic lens has not yet been in which sufficiently has both abrasion resistance and adhesion.

### Patent Document 1: JP-A-9-208651

### Patent Document 2: JP-A-2001-330701

### DISCLOSURE OF THE INVENTION

### Problems to be Solved by the Invention

The present invention has been made for solving the problems, and an object thereof is to provide a plastic lens having favorable adhesion and abrasion resistance with a lens containing a resin having an NHCO structure represented by the formula (A) shown later or a resin having a unit derived from a compound represented by the formula (B) shown later used as a substrate.

### Means for Solving the Problems

As a result of earnest investigations for attaining the objects made by the inventors, it has been found that upon forming a cured film on the aforementioned substrate by reacting a coating composition containing the following components (i), (ii) and (iii), —H and —O in the carboxylic amide bond (carbonyldiimino structure) present on the surface of the lens form hydrogen bonds with —O and —H in the composition forming a hard coat to enhance the adhesion, thereby providing a plastic lens having favorable adhesion and abrasion resistance, and thus the present invention has been completed.

Accordingly, the present invention provides a plastic lens containing, as a substrate, a lens containing a resin having an NHCO structure represented by the following formula (A) or a resin having a unit derived from a compound represented by the following formula (B), and a cured film having an NHCO structure formed by reacting a coating composition containing the following components (i), (ii) and (iii) directly on the substrate.

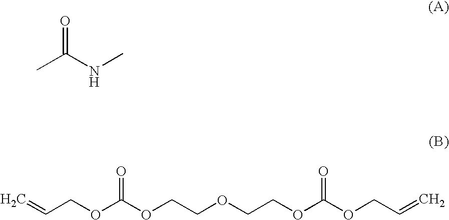

component (i):

at least one selected from an organosilicon compound represented by the following general formula (1), an organosilicon compound represented by the following general formula (2) and a hydrolysate of the organosilicon compounds:

R¹ₙSi(OR²)₄₋ₙ (1)

(in the formula, R¹ represents a monovalent hydrocarbon group having from 3 to 20 carbon atoms and having a functional group (a vinyl group, an epoxy group, a styryl group, a methacryl group or an acrylic group); R² represents an alkyl group having from 1 to 8 carbon atoms, an aryl group having from 6 to 10 carbon atoms, an aralkyl group having from 7 to 10 carbon atoms or an acyl group having from 2 to 10 carbon atoms; and n represents an integer of 1 or 2, in which when plural R¹ groups are present, the plural R¹ groups may be the same or different, and plural OR² groups may be the same or different)

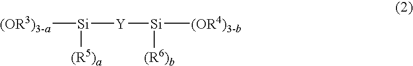

(in the formula, R³ and R⁴ each represent an alkyl group having from 1 to 4 carbon atoms or an acyl group having from 2 to 4 carbon atoms, and may be the same or different; R⁵ and R⁶ each represent a monovalent hydrocarbon group having from 1 to 5 carbon atoms and having or not having a functional group, and may be the same or different; Y represents a divalent hydrocarbon group having from 2 to 20 carbon atoms; and a and b each represent an integer of 0 or 1, in which plural OR³ groups may be the same or different, and plural OR⁴ groups may be the same or different),
component (ii):

at least one selected from an amino group-containing organic compound, a hydroxyl group-containing organic compound, a mercapto group-containing organic compound, an amino group-containing organosilicon compound, a hydroxyl group-containing organosilicon compound and a mercapto group-containing organosilicon compound,

component (iii):

at least one selected from an isocyanate group-containing organic compound and an isocyanate group-containing organosilicon compound.

### ADVANTAGES OF THE INVENTION

The plastic lens of the present invention is excellent in abrasion resistance, transparency and appearance, and in particular, excellent in adhesion to a cured film.

### BEST MODE FOR CARRYING OUT THE INVENTION

The plastic lens of the present invention contains, as a substrate, a lens containing a resin having an NHCO structure represented by the formula (A) or a resin having a unit derived from a compound represented by the formula (B), and a cured film having an NHCO structure formed by reacting a coating composition containing the components (i), (ii) and (iii) directly on the substrate.

The components (i), (ii) and (iii) are described below.

The component (i) is described.

The component (i) in the present invention is at least one selected from an organosilicon compound represented by the general formula (1), an organosilicon compound represented by the general formula (2) and a hydrolysate of the organosilicon compounds.

R¹ₙSi(OR²)₄₋ₙ (1)

In the general formula (1), R¹ represents a monovalent hydrocarbon group having from 3 to 20 carbon atoms and having a functional group (a vinyl group, an epoxy group, a styryl group, a methacryl group or an acrylic group), examples of which include a glycidoxymethyl group, an α-glycidoxyethyl group, a β-glycidoxyethyl group, an α-glycidoxypropyl group, a β-glycidoxypropyl group, a γ-glycidoxypropyl group, an α-glycidoxybutyl group, a β-glycidoxybutyl group, a γ-glycidoxybutyl group, a δ-glycidoxybutyl group, a vinyl group, a vinylmethyl group, a β-epoxycyclohexylethyl group, a p-styryl group, a γ-methacryloxypropyl group, a γ-acryloxy group, a γ-acryloxypropyl group and the like.

In the general formula (1), R² represents an alkyl group having from 1 to 8 carbon atoms, an aryl group having from 6 to 10 carbon atoms, an aralkyl group having from 7 to 10 carbon atoms or an acyl group having from 2 to 10 carbon atoms.

The alkyl group having from 1 to 8 carbon atoms represented by R² may be linear, branched or cyclic, and examples thereof include a methyl group, an ethyl group, a n-propyl group, an isopropyl group, a n-butyl group, an isobutyl group, a sec-butyl group, a tert-butyl group, a pentyl group, a hexyl group, a cyclopentyl group, a cyclohexyl group and the like. Examples of the aryl group include a phenyl group, a tolyl group and the like, examples of the aralkyl group include a benzyl group, a phenethyl group and the like, and examples of the acyl group include an acetyl group and the like.

In the general formula (1), n represents an integer of 1 or 2, in which when plural R¹ groups are present, the plural R¹ groups may be the same or different, and plural OR² groups may be the same or different,

Specific examples of the organosilicon compound represented by the general formula (1) include vinyltrimethoxysilane, vinyltriethoxysilane, vinylmethyldimethoxysilane, vinylmethyldiethoxysilane, β-epoxycyclohexylethyltrimethoxysilane, β-epoxycyclohexylethyltriethoxysilane, β-epoxycyclohexylethylmethyldimethoxysilane, β-epoxycyclohexylethylmethyldiethoxysilane, glycidoxymethyltrimethoxysilane, glycidoxymethyltriethoxysilane, α-glycidoxyethyltrimethoxysilane, α-glycidoxyethyltriethoxysilane, β-glycidoxyethyltrimethoxysilane, β-glycidoxyethyltriethoxysilane, α-glycidoxypropyltrimethoxysilane, α-glycidoxypropyltriethoxysilane, β-glycidoxypropyltrimethoxysilane, β-glycidoxypropyltriethoxysilane, γ-glycidoxypropyltrimethoxysilane, γ-glycidoxypropyltriethoxysilane, γ-glycidoxypropyltripropoxysilane, γ-glycidoxypropyltributoxysilane, γ-glycidoxypropyltriphenoxysilane, α-glycidoxybutyltrimethoxysilane, α-glycidoxybutyltriethoxysilane, β-glycidoxybutyltrimethoxysilane, β-glycidoxybutyltriethoxysilane, γ-glycidoxybutyltrimethoxysilane, γ-glycidoxybutyltriethoxysilane, δ-glycidoxybutyltrimethoxysilane, δ-glycidoxybutyltriethoxysilane, glycidoxymethylmethyldimethoxysilane, glycidoxymethylmethyldiethoxysilane, α-glycidoxyethylmethyldimethoxysilane, α-glycidoxyethylmethyldiethoxysilane, β-glycidoxyethylmethyldimethoxysilane, β-glycidoxyethylmethyldiethoxysilane, α-glycidoxypropylmethyldimethoxysilane, α-glycidoxypropylmethyldiethoxysilane, β-glycidoxypropylmethyldimethoxysilane, β-glycidoxypropylmethyldiethoxysilane, γ-glycidoxypropylmethyldimethoxysilane, γ-glycidoxypropylmethyldiethoxysilane, γ-glycidoxypropylmethyldipropoxysilane, γ-glycidoxypropylmethyldibutoxysilane, γ-glycidoxypropylmethyldiphenoxysilane, γ-glycidoxypropylethyldimethoxysilane, γ-glycidoxypropylethyldiethoxysilane, γ-glycidoxypropylvinyldimethoxysilane, γ-glycidoxypropylphenyldiethoxysilane, p-sytryltrimethhoxysilane, p-stryryltriethoxysilane, p-styryrlmethyldimethoxysilane, p-styryrlmethyldiethoxysilane, γ-methacryloxypropyltrimethoxysilane, γ-methacryloxypropyltriethoxysilane, γ-methacryloxypropylmethyldimethoxysilane, γ-methacryloxypropylmethyldiethoxysilane, γ-acryloxypropyltrimethoxysilane, γ-acryloxypropyltriethoxysilane, γ-acryloxypropylmethyldimethoxysilane, γ-acryloxypropylmethyldiethoxysilane and the like.

Among these, β-epoxycyclohexylethyltrimethoxysilane, β-epoxycyclohexylethyltriethyoxysilane, β-epoxycyclohexylethylmethyldimethoxysilane, β-epoxycyclohexylethylmethyldiethoxysilane, γ-glycidoxypropyltrimethoxysilane, γ-glycidoxypropyltriethoxysilane, γ-glycidoxypropyltripropoxysilane, γ-glycidoxypropyltributoxysilane, γ-glycidoxypropylmethyldimethoxysilane, γ-glycidoxypropylmethyldiethoxysilane, γ-glycidoxypropylmethyldipropoxysilane and γ-glycidoxypropylmethyldibutoxysilane are preferred, and β-epoxycyclohexylethyltrimethoxysilane, β-epoxycyclohexylethyltriethoxysilane, γ-glycidoxypropyltrimethoxysilane, γ-glycidoxypropyltriethoxysilane, γ-glycidoxypropyltripropoxysilane and γ-glycidoxypropyltributoxysilane are more preferred.

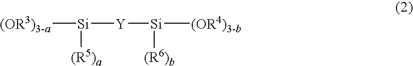

In the general formula (2), R³ and R⁴ each represent an alkyl group having from 1 to 4 carbon atoms or an acyl group having from 2 to 4 carbon atoms, and may be the same or different; and R⁵ and R⁶ each represent a monovalent hydrocarbon group having from 1 to 5 carbon atoms and having or not having a functional group, and may be the same or different.

Examples of the alkyl group represented by R³ and R⁴ include a methyl group, an ethyl group, a n-propyl group, an isopropyl group, a n-butyl group, an isobutyl group, a sec-butyl group, a tert-butyl group and the like, and examples of the acyl group having 2 to 4 carbon atoms include an acetyl group and the like.

Examples of the hydrocarbon group represented by R⁵ and R⁶ include an alkyl group having from 1 to 5 carbon atoms, an alkenyl group having from 2 to 5 carbon atoms and the like. These may be a linear group or a branched group. Examples of the alkyl group include a methyl group, an ethyl group, a n-propyl group, an isopropyl group, a n-butyl group, a sec-butyl group, a tert-butyl group, a pentyl group and the like, and examples of the alkenyl group include a vinyl group, an allyl group, a butenyl group and the like.

Examples of the functional group of the hydrocarbon group include a halogen atom, a glycidoxy group, an epoxy group, an amino group, a mercapto group, a cyano group, a (meth)acryloyloxy group and the like.

In the general formula (2), Y represents a divalent hydrocarbon group having from 2 to 20 carbon atoms, and preferably an alkylene group and an alkylidene group each having from 2 to 10 carbon atoms, examples of which include a methylene group, an ethylene group, a propylene group, a butylene group, an ethylidene group, a propylidene group and the like.

In the general formula (2), a and b each represent an integer of 0 or 1, in which plural OR³ groups may be the same or different, and plural OR⁴ groups may be the same or different .

Specific examples of the organosilicon compound represented by the general formula (2) include bis(triethioxysilyl)ethane, bis(trimethoxysilyl)ethane, bis(triethoxysilyl)methane, bis(trimethoxysilyl)hexane, bis(triethoxysilyl)octane and the like, and bis(triethoxysilyl)ethane and bis(trimethoxysilyl)ethane are preferred.

The component (ii) is described.

The component (ii) in the present invention is at least one selected from an amino group-containing organic compound, a hydroxyl group-containing organic compound, a mercapto group-containing organic compound, an amino group-containing organosilicon compound, a hydroxyl group-containing organosilicon compound and a mercapto group-containing organosilicon compound.

Examples of the compound as the component (ii) include xylylenediamine, adipoamide, adipic acid dihydrazide, alanine, β-alanine, allylamine, aminoethanol, 2-(2-aminoethylamino)ethanol, 2-(2-aminoethoxy)ethanol, 4-(aminomethyl)piperidine, 1-amino-2-propanol, 3-amino-1-propanol, 3-amino-1,2-propanediol, 4-aminobenzamide, 2-aminoethanethiol, aminoacetaldehyde dimethylacetal, 1-amino-2-butanol, N-aminomorpholine, 5-amino-1-pentanol, N-(2-aminoethyl)morpholine, 1-(2-aminoethyl)pyrrolidine, N-acetylethylenediamine, N-(3-aminopropyl)cyclohexylamine, 4-amino-1-butanol, 2-amino-1-phenylethanol, 1-(2-aminoethyl)piperidine, 6-amino-1-hexanal, 3-amino-N-methylbenzoamide, 4-amino-1-benzylpiperidine, 4-aminocyclohexanal, 2-amino-1,3-propanediol, 2-aminocyclohexanol, N-(3-aminopropyl)diethanolamine, 3-aminobenzylamine, 2-aminobenzylamine, 4-aminobenzylamine, 2-(4-aminophenyl)ethylamine, 8-amino-1-octanol, 10-amino-1-decanol, 12-amino-1-dodecanol, biurea, biuret, N,N-bis(3-aminopropyl)methylamine, 1,4-butanediol bis(3-aminopropyl) ether, bis(3-aminopropyl) ether, 1,2-bis(2-aminoethoxy)ethane, N,N-bis(2-aminoethyl)-1,3-propanediamine, N,N-bis(2-hydroxyethyl)oxamide, 3,9-bis(3-aminopropyl)-2,4,8,10-tetraoxaspiro[5.5]undecane, N,N-bis(3-aminopropyl)ethylenediamine, carbohydrazide, 1,3-cyclohexanediamine, 1,4-cyclohexanediamine, 1,10-diaminodecane, 3,3-diaminodipropylamine, 1,12-diaminododecane, 1,7-diaminoheptane, 1,6-diaminohexane, 1,9-diaminononane, 1,8-diaminooctane, 1,5-diaminopentane, 1,3-diaminopropane, 1,4-diaminobutane, 1,2-cyclohexanediamine, diethylenetriamine, diethylene glycol bis(3-aminopropyl) ether, ethylene glycol bis(3-aminopropyl) ether, 1,11-diaminoundecane, 1,3-diaminopentane, 1,2-diphenylethylenediamine, ethylenediamine, N-ethylethylenediamine, homocysteine, homocystine, N-(3-hydroxypropyl)ethylenediamine, 1,3-diamino-2-propanol, 2-((hydroxymethyl)amino)ethanol, diethanolamine, 2-methyl-1,5-diaminopentane, N-methylethylenediamine, N-methyl-1,3-diaminopropane, N-methyl-2,2-diaminodiethylamine, 4,4-methylenebis(2-methylcyclohexylamine), 2-methyl-1,3-propanediamine, oxyldihydrazide, oxamide, oxamic acid hydrazide, 2,2-oxybis(ethylamine), phthalamide, piperazine, pentaethylenehexamine, N,N,N′,N′,N″-pentakis(2-hydroxypropyl)diethylenetriamine, N-phenylethylenediamine, succinic amide, diethanolamine, triethanolamine, succinic dihydrazide, terephthalic amide, tetraethylenepentamine, 2,2′,2″,2″′-ethylenedinitrilotetraethanol, thiosemicarbazide, 1-(O-tolyl)biguanide, triethylenetetramine, thiocarbohydrazide, tri(2-aminoethyl)amine, 2,2′-thiobis(ethylamine), tri(3-aminopropyl)amine, thiourea, urea, β-aminoethylaminopropylmethyldimethoxysilane, β-aminoethylaminopropylmethyldiethoxysilane, β-aminoethylaminopropyltrimethoxysilane, β-aminoethylaminopropyltriethoxysilane, γ-aminopropylmethyldimethoxysilane, γ-aminopropylmethyldiethoxysilane, γ-aminopropyltrimethoxysilane, γ-aminopropyltriethoxysilane, N-phenyl-γ-aminopropylmethyldimethoxysilane, N-phenyl-γ-aminopropylmethyldiethoxysilane, N-phenyl-γ-aminopropyltrimethoxysilane, N-phenyl-γ-aminopropyltriethoxysilane, γ-ureidopropylmethyldimethoxysilane, γ-ureidopropylmethyldiethoxysilane, γ-ureidopropylmethyltrimethoxysilane, γ-ureidopropylmethyltriethoxysilane, bis(γ-triethoxysilylpropyl)amine, bis(γ-trimethoxysilylpropyl)amine, bis(γ-methyldiethoxysilylpropyl)amine, bis(γ-methyldimethoxysilylpropyl)amine, ribitol, adrenaline, allyl alcohol, arabinose, arabitol, arbutin, gallein, 1,4-butanediol, 2,3-butanediol, 1,2,4-butanetriol, cis-2-butene-1,4-diol, 1,2,3-butanetriol, 2,2-bis(4-hydroxycyclohexyl)propane, 2-butine-1,4-diol bis(2-hydroxyethyl) ether, 3,9-bis(1,1-dimethyl-2-hydroxyethyl)-2,4,8,10-tetraoxaspiro[5.5]undecane, 1,3-butanediol, 2,6-bis(hydroxymethyl)-p-cresol, 4,4-bicyclohexanol, 1,3-bis(2-hydroxyethoxy)benzene, 2,2-bis(hydroxymethyl) diphenyl ether, 2,6-bis(hydroxymethyl)-1,4-dimethoxybenzene, 4,4-biphenyldimethanol, 1,4-cyclohexanedimethanol, 1,2-cyclohexanediol, 1,3-cyclohexanediol, 1,4-cyclohexanediol, 1,2,3-cyclohexanetriol, dihydroxyacetone dimer, 2,3-dimercapto-1-propanol, dithiothreitol, 2,5-dihydroxy-1,4-dithiane, 2,2-bis(bromomethyl)-1,3-propanediol, 3,6-dithia-1,8-octanediol, 2,4-diethyl-1,5-pentanediol, 3,4-dihydroxybenzyl alcohol, 3,6-dioxa-1,8-octanedithiol, 3,5-dihydroxybenzyl alcohol, 1,2,10-decanetriol, 3,7-dithia-1,9-nonanediol, decaethylene glycol, dodecaethylene glycol, meso-erythritol, ethylene glycol, 3,3-ethylenedioxydiphenol, 9,9-bis(4-(2-hydroxyethoxy)phenyl)fluorene, 1,7-heptanediol, 1,6-hexanediol, 2,5-hexanediol, 1,2,6-hexanetriol, 1,2,7-heptanetriol, heptaethylene glycol, 2-mercaptoethanol, 3-methoxy-1,2-propanediol, 3-methyl-1,5-pentanediol, 3-(N-morpholino)-1,2-propanediol, 2-methyl-1,3-propanediol, 3-mercapto-1-propanol, naringenin, 1,9-nonanediol, 1,2,9-nonanetriol, 1,8-octanediol, bis(2-mercaptoethyl) ether, 1,2,8-octanetriol, 1,5-pentanediol, 2,4-pentanediol, phenylethylene glycol, N,N-bis(2-hydroxypropyl)aniline, 2,6-pyridinemethanol, 1,2-pentanediol, 2-phenyl-1,3-propanediol, 1,2,5-pentanetriol, glycerol, α-thioglycerol, 2,2-dithiodiethanol, diglycerol, 2,2-thiodiethanol, triethylene glycol, o-xylylene glycol, 1,4-butanedithiol, 1,4-bis(mercaptomethyl)benzene, 1,10-decanedithiol, 3,6-dioxa-1,8-octanedithiol, 3,7-dithia-1,9-nonanedithiol, 1,2-ethanedithiol, 1,6-hexanedithiol, 2-mercaptomethylsulfide, 1,3-propanedithiol, 1,5-pentanedithiol, γ-mercaptopropylmethyldimethoxysilane, γ-mercaptopropylmethyldiethoxysilane, γ-mercaptopropyltrimethoxysilane, γ-mercaptopropyltriethoxysilane and the like.

Among these, 1,5-diaminopentane, 1,3-diaminopropane, 1,4-diaminobutane, 1,2-cyclohexanediamine, 1,3-cyclohexanediamine, 1,4-cyclohexanediamine, diethylenetriamine, 1,3-diamino-2-propanol, 2-((hydroxymethyl)amino)ethanol, diethanolamine, 2,2-oxybis(ethylamine), phthalamide, piperazine, pentaethylenehexamine, diethanolamine, triethanolamine, tetraethylenepentamine, 2,2′,2″,2′″-ethylenedinitrilotetraethanol, triethylenetetramine, (2-aminoethyl)amine, 2,2′-thiobis(ethylamine), β-aminoethylaminopropylmethyldimethoxysilane, β-aminoethylaminopropylmethyldiethoxysilane, β-aminoethylaminopropyltrimethoxysilane, β-aminoethylaminopropyltriethoxysilane, γ-aminopropylmethyldimethoxysilane, γ-aminopropylmethyldiethoxysilane, γ-aminopropyltrimethoxysilane, γ-aminopropyltriethoxysilane, N-phenyl-γ-aminopropylmethyldimethoxysilane, N-phenyl-γ-aminopropylmethyldiethoxysilane, N-phenyl-γ-aminopropyltrimethoxysilane, N-phenyl-γ-aminopropyltriethoxysilane, γ-ureidopropylmethyldimethoxysilane, γ-ureidopropylmethyldiethoxysilane, γ-ureidopropylmethyltrimethoxysilane, γ-ureidopropylmethyltriethoxysilane, bis(γ-triethoxysilylpropyl)amine, bis(γ-trimethoxysilylpropyl)amine, bis(γ-methyldiethoxysilylpropyl)amine, bis(γ-methyldimethoxysilylpropyl)amine, 1,4-butanediol, 2,3-butanediol, 1,2,4-butanetriol, 1,2,3-butanetriol, 2,2-bis(4-hydroxycyclohexyl)propane, 1,4-cyclohexanedimethanol, 1,2-cyclohexanediol, 1,3-cyclohexanediol, 1,4-cyclohexanediol, 2,5-dihydroxy-1,4-dithiane, 3,6-dithia-1,8-octanediol, 1,7-heptanediol, 1,6-hexanediol, 1,2,7-heptanetriol, 1,5-pentanediol, 2,4-pentanediol, phenylethylene glycol, 1,2-pentanediol, glycerol, α-thioglycerol, 2,2-dithiodiethanol, diglycerol, 2,2-thiodiethanol, 2-mercaptomethylsulfide, 1,3-propanedithiol, 1,5-pentanedithiol, γ-mercaptopropylmethyldimethoxysilane, γ-mercaptopropylmethyldiethoxysilane, γ-mercaptopropyltrimethoxysilane and γ-mercaptopropyltriethoxysilane are preferred, and 1,5-diaminopentane, 1,3-diaminopropane, 1,4-diaminobutane, 1,2-cyclohexanediamine, 1,3-cyclohexanediamine, 1,4-cyclohexanediamine, diethylenetriamine, β-aminoethylaminopropylmethyldimethoxysilane, β-aminoethylaminopropylmethyldiethoxysilane, β-aminoethylaminopropyltrimethoxysilane, β-aminoethylaminopropyltriethoxysilane, γ-aminopropylmethyldimethoxysilane, γ-aminopropylmethyldiethoxysilane, γ-aminopropyltrimethoxysilane, γ-aminopropyltriethoxysilane, N-phenyl-γ-aminopropylmethyldimethoxysilane, N-phenyl-γ-aminopropylmethyldiethoxysilane, N-phenyl-γ-aminopropyltrimethoxysilane, N-phenyl-γ-aminopropyltriethoxysilane, bis(γ-triethoxysilylpropyl)amine, bis(γ-trimethoxysilylpropyl)amine, bis(γ-methyldiethoxysilylpropyl)amine, bis(γ-methyldimethoxysilylpropyl)amine, 1,2,4-butanetriol, 1,2,3-butanetriol, 2,5-dihydroxy-1,4-dithiane, 1,2,7-heptanetriol, 2,2-dithiodiethanol, diglycerol, 2,2-thiodiethanol, α-thioglycerol, 1,4-butanedithiol, 2-mercaptomethylsulfide, 1,3-propanedithiol, 1,5-pentanedithiol, γ-mercaptopropylmethyldimethoxysilane, γ-mercaptopropylmethyldiethoxysilane, γ-mercaptopropyltrimethoxysilane and γ-mercaptopropyltriethoxysilane are more preferred.

As the component (ii), at least one selected from an amino group-containing organosilicon compound represented by the following general formula (3) and a hydrolysate thereof is preferred:

R⁷ₙSi(OR⁸)₄₋ₙ (3)

In the general formula (3), R⁷ represents a monovalent amino group-containing hydrocarbon group having from 1 to 20 carbon atoms, examples of which include γ-aminopropyl group, an N-(β-aminoethyl)-γ-aminopropyl group, an N-phenyl-γ-aminopropyl group and the like.

In the general formula (3), R⁸ represents an alkyl group having from 1 to 8 carbon atoms, an aryl group having from 6 to 10 carbon atoms, an aralkyl group having from 7 to 10 carbon atoms or an acyl group having from 2 to 10 carbon atoms, examples of which include the same groups shown for R².

In the general formula (3), n represents an integer of 1 or 2, in which when plural R⁷ groups are present, the plural R⁷ groups may be the same or different, and plural OR⁸ groups may be the same or different.

Specific examples of the organosilicon compound represented by the general formula (3) include γ-aminopropyltrimethoxysilane, γ-aminopropyldimethoxymethylsilane, γ-aminopropyltriethoxysilane, γ-aminopropyldiethoxymethylsilane, N-β-(aminoethyl)-γ-aminopropyldimethoxymethylsilane, N-β-(aminoethyl)-γ-aminopropyltrimethoxysilane, N-β-(aminoethyl)-γ-aminopropyltriethoxysilane, N-β-(aminoethyl)-γ-aminopropyldiethoxymethylsilane, N-phenyl-γ-aminopropyltrimethoxysilane, N-phenyl-γ-aminopropyldimethoxymethylsilane, N-phenyl-γ-aminopropyltriethoxysilane, N-phenyl-γ-aminopropyldiethoxymethylsilane and the like.

Among these, γ-aminopropyltrimethoxysilane, γ-aminopropyltriethoxysilane, γ-aminopropyldimethoxymethylsilane and γ-aminopropyldiethoxymethylsilane are preferred, and a γ-aminopropyltrialkoxysilane, such as γ-aminopropyltrimethoxysilane and γ-aminopropyltriethoxysilane, is more preferred.

The component (iii) is described.

The component (iii) in the present invention is at least one selected from an isocyanate group-containing organic compound and an isocyanate group-containing organosilicon compound.

Examples of the compound as the component (ii) include 1,3-bis(2-isocyanate-2-propyl)benzene, 1,3-bis(isocyanatemethyl)cyclohexane, dicyclohexylmethane 4,4-diisocyanate, hexamethylene diisocyanate, isopropyl isocyanate, butyl isocyanate, cyclohexyl isocyanate, ethyl isocyanate, propyl isocyanate, isophorone diisocyanate, benzyl isocyanate, hexyl isocyanate, phenethyl isocyanate, xylylene diisocyanate, γ-isocyanatopropylmethyldimethoxysilane, γ-isocyanatopropylmethyldiethoxysilane, γ-isocyanatopropyltrimethoxysilane, γ-isocyanatopropyltriethoxysilane and the like.

Among these, 1,3-bis(2-isocyanate-2-propyl)benzene, 1,3-bis(isocyanatemethyl)cyclohexane, dicyclohexylmethane 4,4-diisocyanate, hexamethylene diisocyanate, isophorone diisocyanate, xylylene diisocyanate, γ-isocyanatopropylmethyldimethoxysilane, γ-isocyanatopropylmethyldiethoxysilane, γ-isocyanatopropyltrimethoxysilane and γ-isocyanatopropyltriethoxysilane are preferred, and 1,3-bis(isocyanatemethyl)cyclohexane, dicyclohexylmethane 4,4-diisocyanate, hexamethylene diisocyanate, isophorone diisocyanate, xylylene diisocyanate, γ-isocyanatopropylmethyldimethoxysilane, γ-isocyanatopropylmethyldiethoxysilane, γ-isocyanatopropyltrimethoxysilane and γ-isocyanatopropyltriethoxysilane are more preferred.

As the component (iii), at least one selected from an isocyanate group-containing organosilicon compound represented by the following general formula (4) and a hydrolysate thereof is preferred:

R⁹ₙSi(OR¹⁰)₄₋ₙ (4)

In the general formula (4), R⁹ represents a monovalent isocyanate group-containing hydrocarbon group having from 1 to 20 carbon atoms, examples of which include an isocyanatomethyl group, an α-isocyanatoethyl group, a β-isocyanatoethyl group, an α-isocyanatopropyl group, a β-isocyanatopropyl group, a γ-isocyanatopropyl group and the like.

In the general formula (4), R¹⁰ represents an alkyl group having from 1 to 8 carbon atoms, an aryl group having from 6 to 10 carbon atoms, an aralkyl group having from 7 to 10 carbon atoms or an acyl group having from 2 to 10 carbon atoms, examples of which include the same groups shown for R².

In the general formula (4), n represents an integer of 1 or 2, in which when plural R⁹ groups are present, the plural R⁹ groups may be the same or different, and plural OR¹⁰ groups may be the same or different.

Specific examples of the organosilicon compound represented by the general formula (4) include γ-isocyanatopropyltrimethoxysilane, γ-isocyanatopropyldimethoxymethylsilane, γ-isocyanatopropyltriethoxysilane, γ-isocyanatopropyldiethoxymethylsilane and the like, and a γ-isocyanatopropyltrialkoxysilane, such as γ-isocyanatopropyltrimethoxysilane and γ-isocyanatopropyltriethoxysilane, is preferred.

In the coating composition used in the present invention, the molar ratio of the functional groups in the components (i), (ii) and (iii) is from 99/0.5/0/5 to 10/45/45, preferably from 97/1.5/1.5 to 40/30/30, and more preferably from 95/2.5/2.5 to 80/10/10.

The coating composition in the present invention may contain, depending on desire, a curing agent for accelerating reaction, a metallic oxide in a fine particle form for adjusting the refractive index to the lens as the substrate, and various kinds of organic solvents and surfactants for enhancing the wettability of the coating composition upon coating to improve the smoothness of the cured film. Furthermore, an ultraviolet ray absorbent, an antioxidant, a light stabilizer and the like may be added unless the properties of the cured film are impaired.

Examples of the curing agent include, while not limited, an amine compound, such as allylamine, ethylamine and the like, a salt or a metallic salt having various kinds of acids and bases including a Lewis acid and a Lewis base, such as an organic carboxylic acid, chromic acid, hypochlorous acid, boric acid, perchloric acid, bromic acid, selenious acid, thiosulfuric acid, orthosilicic acid, thiocyanic acid, nitrous acid, aluminic acid, carbonic acid and the like, a metallic alkoxide or a metallic chelate compound thereof having aluminum, zirconium or titanium, and the like. Particularly preferred examples the curing agent include a metallic acetylacetonate salt from the standpoint of abrasion resistance. Examples of the metallic acetylacetonate salt include a metallic complex compound represented by M¹(CH₃COCHCOCH₃)ₙ₁(OR)ₙ₂ (wherein M¹ represents Zn(II), Ti(IV), Co(II), Fe(II), Cr(III), Mn(II), V(III), V(IV), Ca(II), Co(III), Cu(II), Mg(II) or Ni(II); R represents a hydrocarbon group having from 1 to 8 carbon atoms; and n1+n2 is a value corresponding to the valence of M¹ and is 2, 3 or 4, in which n2 is 0, 1 or 2). Examples of R include the groups having from 1 to 8 carbon atoms shown for the groups in the general formulae (1) to (4).

Examples of the metallic oxide in a fine particle form include, while not limited, fine particles of aluminum oxide, titanium oxide, antimony oxide, zirconium oxide, silicon oxide, cerium oxide, iron oxide, a modified zirconium oxide-stannic oxide complex sol and the like, and the following sol is used from the standpoint of enhancement of abrasion resistance and suppression of interference fringes.

Among these, such modified zirconium oxide-stannic oxide complex colloid particles (C) are preferred that contains zirconium oxide-stannic oxide complex colloid particles (A2) having a structure containing colloid particles of zirconium oxide and colloid particles of stannic oxide bonded at a ratio of from 0.02 to 0.4 in terms of SnO₂/ZnO₂ based on the molar ratio of the oxides, having a particle diameter of from 2.5 to 100 nm, and containing amine-containing Sb2O₅, as a core, having coated on the surface thereof colloid particles (B2) of a tungsten oxide-stannic oxide-silicon dioxide complex having a mass ratio WO₃/SnO₂ of from 0.1 to 100, a mass ratio SiO₂/SnO₂ of from 0.1 to 100 and a particle diameter of from 2 to 7 nm, with a mass ratio (B2)/(A2) being from 0.02 to 1 based on the mass ratio of the metal oxides thereof, and that has a particle diameter of from 2.5 to 100 nm.

In the present invention, it is preferred that the component (ii) and the component (iii) are reacted with each other, and then the component (i) is added thereto and reacted therewith since the adhesion is further improved.

Examples where the component (ii) and the component (iii) are reacted with each other include the following examples 1 to 3.

Example 1: Component (ii) (Amino Group-containing Organic Compound)+Component (iii) (Isocyanate Silane Coupling Agent)

An isocyanate silane coupling agent is reacted with an amino group-containing organic compound to provide an organosilicon compound having the corresponding group.

Example: xylylene diamine (center)+isocyanate silane coupling agent on both ends

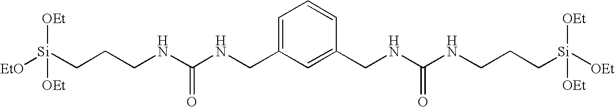

Example 2: Component (ii)) (Hydroxyl Group-containing and Amino Group-containing Organic Compound)+Component (iii) (Isocyanate Silane Coupling Agent)

An isocyanate silane coupling agent is reacted with a hydroxyl group-containing organic compound to provide an organosilicon compound having the corresponding group (urethane).

Example: ethylene glycol (center)+isocyanate silane coupling agent on both ends

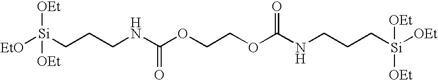

Example 3: Component (ii) (Hydroxyl Group-containing and Amino Group-containing Organic Compound)+Component (iii) (Isocyanate Silane Coupling Agent)

An isocyanate silane coupling agent is reacted with a mercapto group-containing organosilicon compound to provide an organosilicon compound having the corresponding group (thiourethane).

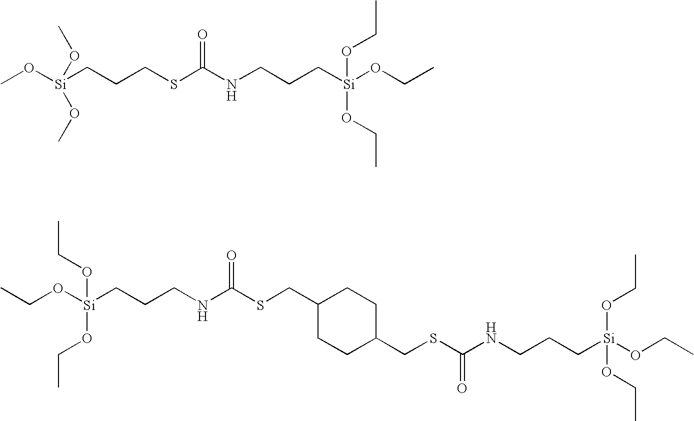

In the present invention, the substrate of the plastic lens contains a resin having an NHCO structure represented by the formula (A):

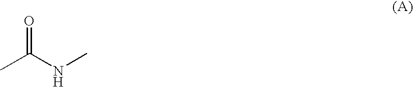

Examples having the NHCO structure include the following structures (a), (b) and (c).

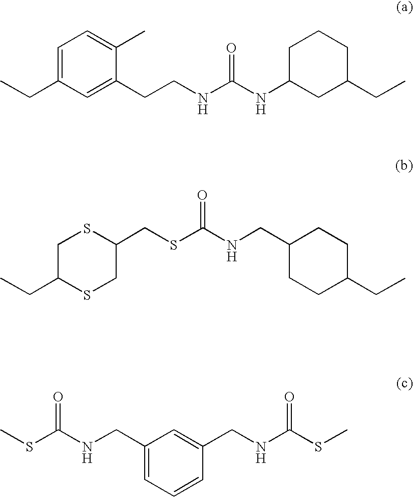

While the aforementioned plastic lens contains both —O and —H in the structure thereof, a plastic lens containing a resin containing, only one of them can be enhanced in adhesion through hydrogen bonds since the hard coat film contains both —O and —H.

In the present invention, the plastic lens may contain a resin having a unit derived from a compound represented by the formula (B) in addition to the aforementioned resin having an NHCO structure:

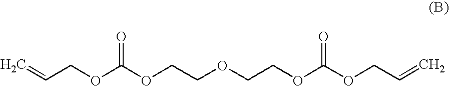

In addition to the aforementioned examples, examples of the lens substrate in the present invention include HOYA EYRY (a trade name, produced by HOYA Corporation), MR-6, MR-7, MR-8 and MR-10 (trade names, produced by Mitsui Chemicals, Inc.), and the like.

The refractive index (nd or ne, where nd is a refractive index measured with helium as the measurement standard wavelength, and ne is a refractive index measured with mercury as the measurement standard wavelength) of the lens substrate is preferably 1.53 or more.

The substrate of the plastic lens of the present invention preferably contains a polythiourethane lens obtained by reacting xylylene diisocyanate and polythiol, or a sulfur-containing lens obtained by reacting a lens raw material monomer containing a compound having an epithio group.

The polythiourethane lens obtained by reacting xylylene diisocyanate and polythiol preferably has a refractive index (nd or ne, where nd is a refractive index measured with helium as the measurement standard wavelength, and ne is a refractive index measured with mercury as the measurement standard wavelength) of about from 1.65 to 1.69, and as the polythiol compound, mercaptomethyldithianeoctaonedithiol and/or bis(mercaptomethyl)trithiaundecanedithiol are preferably used as a component.

In addition to xylylene diisocyanate, another polyisocyanate compound, such as di(isocyanatomethyl)bicycloheptane, bis(isocyanatomethyl)-1,4-dithiane, dicyclohexylmethane diisocyanate and the like, may be added in such an extent that does not impair the other properties. The content molar ratio of xylylene diisocyanate is preferably 50% by mol or more based on the total polyisocyanate compounds.

As for the polythiol compound, in addition to mercaptomethyldithianeoctaonedithiol and/or bis(mercaptomethyl)trithiaundecanedithiol, another polythiol compound (examples of which include an aliphatic thiol, such as methanedithiol, 1,2-ethanedithiol, 1,1-propanedithiol and the like, an aliphatic thiol-containing a sulfur atom in addition to the mercapto group, such as dithiodiglycolic acid bis(2,3-dimercaptopropyl ester), dithiodipropionic acid (2,3-dimercaptopropyl ester), bis(1,3-dimercapto-2-propyl)sulfide and the like, a heterocyclic compound having a sulfur atom in addition to the mercapto group, such as 3,4-thiophenedithiol, tetrahydrothiophene-2,5-dimercaptomethyl and the like, and the like) may be added in such an extent that does not impair the properties of the lens.

The sulfur-containing lens obtained by reacting a lens raw material monomer containing, as an essential component, a compound having an epithio group preferably has a refractive index (nd or ne) of about from 1.69 to 1.72, and examples of the compound having an epithio group include bis(β-epithiopropyl)sulfide and/or bis(β-epithiopropyl)disulfide. In addition to the compound having an epithio group, a known polyisocyanate compound and a known polythiol compound may be added in such an extent that does not impair the other properties. Examples of the polyisocyanate compound and the polythiol compound include those having been described above.

In the sulfur-containing lens, the amount of the compound having an epithio group is preferably from 60 to 90% by weight based on the total amount of the lens raw material monomers.

Examples of the method for forming a cured film on the substrate by using the coating composition in the present invention include a method of coating the coating composition on the substrate. A method that is ordinarily employed, such as a dipping method, a spin coating method, a spraying method and the like, may be used as the coating method, and a dipping method and a spin coating method are particularly desired from the standpoint of surface accuracy.

In the present invention, reaction and curing of the coating composition is generally performed by drying with hot air or irradiation of an active energy ray, and is generally performed under curing conditions of hot air at 70 to 200° C., and preferably from 90 to 150° C. Examples of the active energy ray include a far-infrared ray and the like, whereby damages due to heat can be reduced to low level.

Before coating the coating composition on the substrate, the lens substrate may be subjected to a chemical treatment with an acid, an alkali or various kinds of organic solvents, a physical treatment with plasma, an ultraviolet ray or the like, a detergent treatment using various kinds of detergents, a sand-blast treatment, or a primer treatment using various kinds of resins, thereby enhancing the adhesion between the substrate and the cured film, and the like.

After forming the cured film by coating the coating composition on the lens substrate, an antireflection film containing an inorganic oxide or an organic oxide as a raw material may, be formed on the cured film by a physical vapor deposition method, such as a vacuum deposition method, a sputtering method and the like. Furthermore, for example, various functional films having, for example, water repellency, antistatic property, antifogging property and the like may be applied on the antireflection film indirectly, directly or in combination.

The plastic lens of the present invention can be preferably used as a lens for spectacles.

In this case, the difference in refractive index between the lens substrate and the cured film is preferably adjusted, and the difference in refractive index is preferably ±0.3 or less, and preferably does not exceed ±0.5.

EXAMPLE

The present invention will be described in more detail with reference to examples, but the present invention is not limited to the examples.

The evaluations of properties in Examples and

Comparative Examples were performed as follows.

### Evaluation Methods

### (1) Evaluation of Adhesion

The cured film or the antireflection film was cross-cut into 100 squares at an interval of 1.5 mm, and an adhesive tape (Cellotape, a trade name, produced by Nichiban Co., Ltd.) was firmly adhered to the cross-cut area. Thereafter, the adhesive tape was quickly peeled off, and then the state of peel-off of the cured film was investigated. The evaluation standard was as follows.

AA no peel-off
A from 1 to 10 squares peeled off
B from 11 to 50 squares peeled off
C from 51 to 100 squares peeled off

### (2) Evaluation of Abrasion Resistance

The surface of the cured film or the antireflection film was rubbed with steel wool #0000 reciprocally 20 times under a load of 2 kg, and the resistance to scratch marks was visually evaluated. The evaluation standard was as follows.

AA substantially no scratch mark
A less than 5 scratch marks formed
B 5 or more and less than 10 scratch marks formed
C 10 or more scratch marks formed or scratch marks formed equivalently to the optical substrate

### (3) Evaluation of Transparency

The presence of fog in the cured film was visually investigated under a fluorescent lamp in a dark room. The evaluation standard was as follows.

AA no fog found
A substantially no fog found
B slight fog found
C significant fog found

### (4) Evaluation of Cracks

The optical member having the cured film was visually investigated under a fluorescent lamp. The evaluation standard was as follows.

AA no crack formed
A 1 or 2 short cracks of less than 1 mm formed from the edge of the lens
B less than 5 cracks of 1 mm or more formed from the edge or the center of the lens
C 5 or more cracks of 1 mm or more formed from the edge or the center of the lens

### (5) Measurement of Bayer Value

The Bayer value was measured from the difference in change of the haze value with respect to the standard lens by using an abrasion tester, Bayer Abrasion Tester (a trade name, produced by COLTS, Inc.) and Haze Value Measuring Equipment (a trade name, produced by Murakami Color Research Laboratory Co., Ltd.).

### Number of Samples and Measurement Method

(1) Three standard lenses (HOYA Hi-Lux (a trade name, produced by HOYA Corporation, refractive index (ne): 1.50) and three sample lenses were prepared.

(2) The haze value before the abrasion test was measured.

(3) The abrasion test was performed with Bayer Abrasion Tester.

(4) The haze value after the abrasion test was measured.

(5) The Bayer value was calculated from the following expression. An average value of three lenses was obtained.

Bayer value=(change in haze value of standard lens)/(change in haze value of sample lens)

A higher Bayer value means a higher hardness of the film.

### Example 1

### (1) Production of Coating Composition

30 parts by mass of diacetone alcohol (DAA) as a solvent and 2.7 parts by mass of γ-aminopropyltriethoxysilane as the component (ii) (3.8% by mol based on the components (i), (ii) and (iii)) were mixed in an atmosphere at 5° C. 3.0 parts by mass of γ-isocyanatopropyltriethoxysilane as the component (iii) (3.8% by mol based on the components (i), (ii) and (iii)) was added dropwise to the mixed solution under stirring, followed by stirring for 4 hours. Subsequently, 69.8 parts by mass of γ-glycidoxypropyltrimethoxysilane as the component (i) (92.4% by mol based on the components (i), (ii) and (iii)) was mixed therewith, and hydrochloric acid having a concentration of 0.01 mol/L was added dropwise thereto under stirring, followed by stirring for 24 hours. According to the operation, a hydrolysate of a silane coupling agent was obtained.

20 parts by mass of diacetone alcohol (DAA) and 80 parts by mass of propylene glycol monomethyl ether (PGM) as a solvent were mixed with 180 parts by mass of a modified tin oxide-zirconium oxide-tungsten oxide-silicon oxide composite methanol sol (produced by Nisshan Chemical Industries, Ltd.) obtained according to Production Example 1 disclosed in paragraphs (0048) to (0055) of JP-A-2005-263854 as a sol component under stirring, followed by stirring for 1 hour, in an atmosphere at 5° C. Thereafter, the hydrolysate of a silane coupling agent prepared above was added dropwise thereto under stirring, followed by stirring for 24 hours. Subsequently, 0.25 part by mass of a silicone surfactant (Y-7006, a trade name, produced by Dow Corning Toray Co., Ltd.) and 5 parts by mass of aluminum trisacetylacetnate as a curing agent were added sequentially thereto, followed by stirring for 150 hours. The resulting solution was filtered with a 0.5-μm filter to provide a coating composition. In this Example, the difference in refractive index with respect to the substrate was controlled to prevent interference fringes from occurring.

### (2) Formation of Cured Film

A lens substrate (a lens substrate obtained by reacting xylylene diisocyanate and bis(mercaptomethyl)trithiaundecanedithiol (refractive index (ne): 1.67) hereinafter referred to as “lens substrate A”) was dipped in a 10% by weight sodium hydroxide aqueous solution at 60° C. for 300 seconds, and then rinsed with ion exchanged water for 300 seconds under application of ultrasonic wave of 28 kHz. Finally, the substrate was dried in an atmosphere at 70° C. The sequence of operations was designated as a substrate pretreatment.

The lens substrate A having been subjected to the pretreatment was dipped in the coating composition for 30 seconds and then drawn up therefrom at 30 cm/min by a dipping method, and a cured film (refractive index (ne): 1.65) was formed on the substrate under conditions of 110 ° C. and 60minutes. The evaluation results of the properties thereof are shown in Table 1.

### (3) Formation of Antireflection Film

The plastic lens substrate having the cured film formed thereon was placed in a vapor deposition equipment and heated to 65° C. while evacuating, after evacuating to 2.7 mPa, vapor deposition materials were vapor-deposited thereon by an electron beam heating method to form an antireflection film containing, from the side of the hard coat, a first layer containing SiO₂ having nd=1.46 and nλ=0.08, a second layer containing Nb₂O₅, ZrO₂ and Y₂O₃ having nλ=2.21 and nλ=0.04, a third layer containing SiO₂ having nd=1.46 and nλ=0.55, a fourth layer containing Nb₂O₅, ZrO₂ and Y₂O₃ having nd=2.21 and nλ=0.12, a fifth layer containing SiO₂ having nd=1.46 and nλ=0.09, a sixth layer containing Nb₂O₅, ZrO₂ and Y₂O₃ having nd=2.21 and nλ=0.17, and a seventh layer containing SiO₂ having nd=1.46 and nλ=0.28, wherein nd represents the refractive index, and nλ represents the thickness. The evaluation results of the properties thereof are shown in Table 1.

### Example 2

A cured film and an antireflection film were formed in the same procedures as in Example 1 except that a plastic lens substrate obtained by reacting 9.30 parts by weight of bis(isocyanatomethyl)-1,4-dithiane, 25.70 parts by weight of bis(mercaptomethyl)-1,4-dithiane and 65.0 parts by weight of bis(β-epithiopropyl)sulfide according to the method disclosed in paragraphs [0013] to [0014] of JP-A-2001-330701 (refractive index (ne): 1.70, hereinafter referred to as “lens substrate B”) was used as a lens substrate instead of the lens substrate A. The evaluation results of the properties thereof are shown in Table 1.

### Example 3

A plastic lens was produced in the same manner as in Example 1 except that a sol of composite colloid particles (C) shown below was used instead of the modified tin oxide-zirconium oxide-tungsten oxide-silicon oxide composite methanol sol. The evaluation results of the properties revealed that the similar results as in Example 1 were obtained.

The composite colloid particles (C) used in Example 3 were modified zirconium oxide-stannic oxide complex colloid particles (C) that contains zirconium oxide-stannic oxide composite colloid particles (A2) having a structure containing colloid particles of zirconium oxide and colloid particles of stannic oxide bonded at a ratio of from 0.02 to 0.4 in terms of SnO₂/ZnO₂ based on the molar ratio of the oxides, having a particle diameter of from 2.5 to 100 nm, and containing amine-containing Sb₂O₅, as a core, having coated on the surface thereof colloid particles (B2) of a tungsten oxide-stannic oxide-silicon dioxide complex having a mass ratio WO₃/SnO₂ of from 0.1 to 100, a mass ratio SiO₂/SnO₂ of from 0.1 to 100 and a particle diameter of from 2 to 7 nm, with a mass ratio (B2)/(A2) being from 0.02 to 1 based on the mass ratio of the metallic oxides, and that has a particle diameter of from 2.5 to 100 nm.

### Example 4

A cured film and an antireflection film were formed in the same procedures as in Example 3 except that the lens substrate B was used as a lens substrate instead of the lens substrate A. The evaluation results of the properties thereof are shown in Table 1.

### Example 5

A coating composition was prepared in the same manner as in Example 1 except that a modified tin oxide-titanium oxide-zirconium oxide composite methanol sol (HIT Series, a trade name, produced by Nisshan Chemical Industries, Ltd.) was used instead of the modified tin oxide-zirconium oxide-tungsten oxide-silicon oxide composite methanol sol, and a cured film and an antireflection film were formed on the lens substrate A in the same procedures as in Example 1. The evaluation results of the properties thereof are shown in Table 1.

### Example 6

A cured film and an antireflection film were formed in the same procedures as in Example 5 except that the lens substrate B was used as a lens substrate instead of the lens substrate A. The evaluation results of the properties thereof are shown in Table 1.

### Example 7

A coating composition was prepared in the same manner as in Example 1 except that a modified titanium oxide-silicon oxide-zirconium oxide composite methanol sol (OPT LAKE 1130Z, a trade name, produced by JGC Catalysts and Chemicals Ltd.) was used instead of the modified tin oxide-zirconium oxide-tungsten oxide-silicon oxide composite methanol sol, and a cured film and an antireflection film were formed on the lens substrate A in the same procedures as in Example 1. The evaluation results of the properties thereof are shown in Table 1.

### Example 8

A cured film and an antireflection film were formed in the same procedures as in Example 7 except that the lens substrate B was used as a lens substrate instead of the lens substrate A. The evaluation results of the properties thereof are shown in Table 1.

### Example 9

A coating composition was prepared in the same manner as in Example 1 except that a modified titanium oxide-tin oxide-silicon oxide-zirconium oxide composite methanol sol (OPT LAKE 1120Z, a trade name, produced by JGC Catalysts and Chemicals Ltd.) was used instead of the modified tin oxide-zirconium oxide-tungsten oxide-silicon oxide composite methanol sol, and a cured film and an antireflection film were formed on the lens substrate A in the same procedures as in Example 1. The evaluation results of the properties thereof are shown in Table 1.

### Example 10

A cured film and an antireflection film were formed in the same procedures as in Example 9 except that the lens substrate B was used as a lens substrate instead of the lens substrate A. The evaluation results of the properties thereof are shown in Table 1.

### Example 11

A coating composition was prepared in the same manner as in Example 1 except that 2.9 parts by mass of γ-aminopropyltrimethoxysilane (5.0% by mol based on the components (i), (ii) and (iii)) was used instead of 2.7 parts by mass of γ-aminopropyltriethoxysilane (3.8% by mol based on the components (i), (ii) and (iii)), and the amount of γ-isocyanatopropyltriethoxysilane was changed from 3.0 parts by mass (3.8% by mol based on the components (i), (ii)) and (iii)) to 4.1 parts by mass (5% by mol based on the components (i), (ii) and (iii)), and a cured film and an antireflection film were formed on the lens substrate A in the same procedures as in Example 1. The evaluation results of the properties thereof are shown in Table 1.

### Example 12

A cured film and an antireflection film were formed in the same procedures as in Example 11 except that the lens substrate B was used as a lens substrate instead of the lens substrate A. The evaluation results of the properties thereof are shown in Table 1.

### Example 13

A coating composition was prepared in the same manner as in Example 1 except that 2.6 parts by mass of γ-isocyanatopropyltrimethoxysilane (4% by mol based on the components (i), (ii) and (iii)) was used instead of 3.0 parts by mass of γ-isocyanatopropyltriethoxysilane (3.8% by mol based on the components (i), (ii) and (iii)), and the amount of γ-aminopropyltriethoxysilane was changed from 2.7 parts by mass (3.8% by mol based on the components (i), (ii) and (iii)) to 2.8 parts by mass (4% by mol based on the components (i), (ii) and (iii)), and a cured film and an antireflection film were formed on the lens substrate A in the same procedures as in Example 1. The evaluation results of the properties thereof are shown in Table 1.

### Example 14

A cured film and an antireflection film were formed in the same procedures as in Example 13 except that the lens substrate B was used as a lens substrate instead of the lens substrate A. The evaluation results of the properties thereof are shown in Table 1.

### Example 15

A coating composition was prepared in the same manner as in Example 1 except that 1.7 parts by mass of γ-aminopropyltrimethoxysilane (3.0% by mol based on the components (i), (ii) and (iii)) was used instead of 2.7 parts by mass of γ-aminopropyltriethoxysilane (3.8% by mol based on the components (i), (ii) and (iii)), and 1.9 parts by mass of γ-isocyanatopropyltrimethoxysilane (3.0% by mol based on the components (i), (ii) and (iii)) was used instead of 3.0 parts by mass of γ-isocyanatopropyltriethoxysilane (3.8% by mol based on the components (i), (ii) and (iii)), and a cured film and an antireflection film were formed on the lens substrate A in the same procedures as in Example 1. The evaluation results of the properties thereof are shown in Table 1.

### Example 16

A cured film and an antireflection film were formed in the same procedures as in Example 15 except that the lens substrate B was used as a lens substrate instead of the lens substrate A. The evaluation results of the properties thereof are shown in Table 1.

### Example 17

A cured film and an antireflection film were formed in the same procedures as in Example 1 except that a lens substrate obtained by reacting xylylene diisocyanate and mercaptomethyldithianeoctainedithiol (refractive index: 1.67) hereinafter referred to as “lens substrate C”) was used as a lens substrate instead of the lens substrate A. The evaluation results of the properties thereof are shown in Table 1.

### Example 18

A coating composition was prepared in the same manner as in Example 1 except that two kinds of the component (i), i.e., 3.35 parts by mass of bis(triethoxysilyl) ethane represented by the general formula (2) (3.0% by mol based on the components (i), (ii) and (iii)) in addition to 66.45 parts by mass of γ-glycidoxypropyltrimethoxysilane represented by the general formula (1) as the component (i) (89.4% by mol based on the components (i), (ii) and (iii)), were used, and a cured film and an antireflection film were formed on the lens substrate A in the same procedures as in Example 1. The evaluation results of the properties thereof are shown in Table 1.

### Example 19

A cured film and an antireflection film were formed in the same procedures as in Example 18 except that the lens substrate B was used as a lens substrate instead of the lens substrate A. The evaluation results of the properties thereof are shown in Table 1.

### Example 20

A coating composition was prepared in the same manner as in Example 1 except that two kinds of the component (1), i.e., 3.44 parts by mass of bis(trimethoxysilyl)ethane represented by the general formula (2) (4.0% by mol based on the components (i), (ii) and (iii)) in addition to 66.36 parts by mass of γ-glycidoxypropyltrimethoxysilane represented by the general formula (1) as the component (i) (88.4% by mol based on the components (i), (ii) and (iii)), were used, and a cured film and an antireflection film were formed on the lens substrate A, in the same procedures as in Example 1. The evaluation results of the properties thereof are shown in Table 1.

### Example 21

A cured film and an antireflection film were formed in the same procedures as in Example 20 except that the lens substrate B was used as a lens substrate instead of the lens substrate A. The evaluation results of the properties thereof are shown in Table 1.

### Comparative Example 1

A coating composition was prepared in the same manner as in Example 1 except that γ-aminopropyltriethoxysilane and γ-isocyanatopropyltriethoxysilane were not used, but 75.5 parts by mass of γ-glycidoxypropyltrimethoxysilane (100% by mol based on the components (i), (ii) and (iii)) was used as a silane coupling agent, and a cured film and an antireflection film were formed on the lens substrate A in the same procedures as in Example 1. The evaluation results of the properties thereof are shown in Table 1.

### Comparative Example 2

A cured film and an antireflection film were formed in the same procedures as in Comparative Example 1 except that the lens substrate B was used as a lens substrate instead of the lens substrate A. The evaluation results of the properties thereof are shown in Table 1.

### Comparative Example 3

A coating composition was prepared in the same manner as in Example 1 except that γ-aminopropyltriethoxysilane was not used, but 5.7 parts by mass of γ-isocyanatopropyltriethoxysilane (7.2% by mol based on the components (i), (ii) and (iii)) and 69.8 parts by mass of γ-glycidoxypropyltrimethoxysilane (92.8% by mol based on the components (i), (ii) and (iii)) were used as a silane coupling agent, and a cured film and an antireflection film were formed on the lens substrate A in the same procedures as in Example 1. The evaluation results of the properties thereof are shown in Table 1.

### Comparative Example 4

A cured film and an antireflection film were formed in the same procedures as in Comparative Example 3 except that the lens substrate B was used as a lens substrate instead of the lens substrate A. The evaluation results of the properties thereof are shown in Table 1.

### Comparative Example 5

A coating composition was prepared in the same manner as in Example 1 except that γ-isocyanatopropyltriethoxysilane was not used, but 5.7 parts by mass of γ-aminopropyltriethoxysilane (8.0% by mol based on the components (i), (ii) and (iii)) and 69.8 parts by mass of γ-glycidoxypropyltrimethoxysilane (92.0% by mol based on the components (i), (ii) and (iii)) were used as a silane coupling agent, and a cured film and an antireflection film were formed on the lens substrate A in the same procedures as in Example 1. The evaluation results of the properties thereof are shown in Table 1.

### Comparative Example 6

A cured film and an antireflection film were formed in the same procedures as in Comparative Example 5 except that the lens substrate B was used as a lens substrate instead of the lens substrate A. The evaluation results of the properties thereof are shown in Table 1.

### Comparative Example 7

A coating composition was prepared in the same manner as in Example 1 except that γ-glycidoxypropyltrimethoxysilane was not used, but 35.6 parts by mass of γ-aminopropyltriethoxysilane (50.0% by mol based on the components (i), (ii) and (iii)) and 39.9 parts by mass of γ-isocyanatopropyltriethoxysilane (50.0% by mol based on the components (i), (ii) and (iii)) were used as a silane coupling agent, and a cured film and an antireflection film were formed on the lens substrate A in the same procedures as in Example 1. The evaluation results of the properties thereof are shown in Table 1.

### Comparative Example 8

A cured film and an antireflection film were formed in the same procedures as in Comparative Example 7 except that the lens substrate B was used as a lens substrate instead of the lens substrate A. The evaluation results of the properties thereof are shown in Table 1.

TABLE 1

| | | | | | | | | Abrasion | | | | |
|---|---|---|---|---|---|---|---|---|---|---|---|---|
| | | Hard coat composition | | | | Adhesion | | resistance | | Transparency | | |
| | | Component | | Component | Component | | Antire- | | Antire- | | Antire- | Crack |
| | Sub- | (i) | | (ii) | (iii) | Cured | flection | Cured | flection | Cured | flection | Cured |
| | strate | (1) | (2) | (3) | (4) | film | film | film | film | film | film | film |
| Example 1 | A | 92.4 mol % | 0 mol % | 3.8 mol % | 3.8 mol % | AA | AA | AA | AA | AA | AA | AA |
| Example 2 | B | 92.4 mol % | 0 mol % | 3.8 mol % | 3.8 mol % | AA | AA | AA | AA | AA | AA | AA |
| Example 3 | A | 92.4 mol % | 0 mol % | 3.8 mol % | 3.8 mol % | AA | AA | AA | AA | AA | AA | AA |
| Example 4 | B | 92.4 mol % | 0 mol % | 3.8 mol % | 3.8 mol % | AA | AA | AA | AA | AA | AA | AA |
| Example 5 | A | 92.4 mol % | 0 mol % | 3.8 mol % | 3.8 mol % | AA | AA | AA | AA | AA | AA | AA |
| Example 6 | B | 92.4 mol % | 0 mol % | 3.8 mol % | 3.8 mol % | AA | AA | AA | AA | AA | AA | AA |
| Example 7 | A | 92.4 mol % | 0 mol % | 3.8 mol % | 3.8 mol % | AA | AA | AA | AA | AA | AA | AA |
| Example 8 | B | 92.4 mol % | 0 mol % | 3.8 mol % | 3.8 mol % | AA | AA | AA | AA | AA | AA | AA |
| Example 9 | A | 92.4 mol % | 0 mol % | 3.8 mol % | 3.8 mol % | AA | AA | AA | AA | AA | AA | AA |
| Example 10 | B | 92.4 mol % | 0 mol % | 3.8 mol % | 3.8 mol % | AA | AA | AA | AA | AA | AA | AA |
| Example 11 | A | 90.0 mol % | 0 mol % | 5.0 mol % | 5.0 mol % | AA | AA | AA | AA | AA | AA | AA |
| Example 12 | B | 90.0 mol % | 0 mol % | 5.0 mol % | 5.0 mol % | AA | AA | AA | AA | AA | AA | AA |
| Example 13 | A | 92.0 mol % | 0 mol % | 4.0 mol % | 4.0 mol % | AA | AA | AA | AA | AA | AA | AA |
| Example 14 | B | 92.0 mol % | 0 mol % | 4.0 mol % | 4.0 mol % | AA | AA | AA | AA | AA | AA | AA |
| Example 15 | A | 94.0 mol % | 0 mol % | 3.0 mol % | 3.0 mol % | AA | AA | AA | AA | AA | AA | AA |
| Example 16 | B | 94.0 mol % | 0 mol % | 3.0 mol % | 3.0 mol % | AA | AA | AA | AA | AA | AA | AA |
| Example 17 | C | 92.4 mol % | 0 mol % | 3.8 mol % | 3.8 mol % | AA | AA | AA | AA | AA | AA | AA |
| Example 18 | A | 89.4 mol % | 3.0 mol % | 3.8 mol % | 3.8 mol % | AA | AA | AA | AA | AA | AA | AA |
| Examp1e 19 | B | 89.4 mol % | 3.0 mol % | 3.8 mol % | 3.8 mol % | AA | AA | AA | AA | AA | AA | AA |
| Example 20 | A | 88.4 mol % | 4.0 mol % | 3.8 mol % | 3.8 mol % | AA | AA | AA | AA | AA | AA | AA |
| Example 21 | B | 88.4 mol % | 4.0 mol % | 3.8 mol % | 3.8 mol % | AA | AA | AA | AA | AA | AA | AA |
| Comparative | A | 100.0 mol % | 0 mol % | 0 mol % | 0 mol % | C | C | AA | AA | AA | AA | B |
| Example 1 | | | | | | | | | | | | |
| Comparative | B | 100.0 mol % | 0 mol % | 0 mol % | 0 mol % | C | C | AA | AA | AA | AA | B |
| Example 2 | | | | | | | | | | | | |
| Comparative | A | 92.8 mol % | 0 mol % | 0 mol % | 7.2 mol % | B | B | A | A | B | B | AA |
| Example 3 | | | | | | | | | | | | |
| Comparative | B | 92.8 mol % | 0 mol % | 0 mol % | 7.2 mol % | B | B | A | A | B | B | AA |
| Example 4 | | | | | | | | | | | | |
| Comparative | A | 92.0 mol % | 0 mol % | 8.0 mol % | 0 mol % | B | B | A | A | B | B | AA |
| Example 5 | | | | | | | | | | | | |
| Comparative | B | 92.0 mol % | 0 mol % | 8.0 mol % | 0 mol % | B | B | A | A | B | B | AA |
| Example 6 | | | | | | | | | | | | |
| Comparative | A | 0 mol % | 0 mol % | 50.0 mol % | 50.0 mol % | AA | AA | B | B | AA | AA | AA |
| Example 7 | | | | | | | | | | | | |
| Comparative | B | 0 mol % | 0 mol % | 50.0 mol % | 50.0 mol % | AA | AA | B | B | AA | AA | AA |
| Example 8 | | | | | | | | | | | | |

### Example 22

### (1) Production of Coating Composition

50 parts by mass of diacetone alcohol (DAA) and 50 parts by mass of propylene glycol monomethyl ether (PGM) as a solvent and 5.2 parts by mass of β-aminoethylaminopropyltriethoxysilane as the component (ii) were mixed in an atmosphere at 5° C. 9.8 parts by mass of γ-isocyanatopropyltriethoxysilane as the component (iii) was added dropwise to the mixed solution under stirring, followed by stirring for 24 hours. Subsequently, 60.0 parts by mass of γ-glycidoxypropyltrimethoxysilane as the component (i) was mixed therewith, and 17.6 parts by mass of 0.01 mol/L hydrochloric acid was then added dropwise thereto under stirring, followed by stirring for 48 hours. According to the operation, a hydrolysate of an organosilicon compound was obtained.

187 parts by mass of a modified zirconium oxide-stannic oxide composite methanol sol as s sol component and 99.1 parts by mass of propylene glycol monomethyl ether (PGM) were mixed, followed by stirring for 1 hour, in an atmosphere at 5° C. Thereafter, the hydrolysate of an organosilicon compound prepared above was added dropwise thereto under stirring, followed by stirring for 1 hour. Subsequently, 0.25 part by mass of a silicone surfactant (Y-7006, a trade name, produced by Dow Corning Toray Co. , Ltd.) and 7.5 parts by mass of aluminum trisacetylacetnate as a curing agent were added sequentially thereto, followed by stirring for 150 hours. The resulting solution was filtered with a 0.5-μm filter to provide a coating composition.

### (2) Formation of Cured Film

A cured film was formed in the same manner as in Example 1 except that the lens substrate B was used instead of the lens substrate A. The evaluation results of the properties thereof are shown in Table 2.

### (3) Formation of Antireflection Film

An antireflection film was formed in the same manner as in Example 1. The evaluation results of the properties thereof are shown in Table 2.

### Example 23

A cured film and an antireflection film were formed in the same procedures as in Example 22 except that the lens substrate A was used as a lens substrate instead of the lens substrate B. The evaluation results of the properties thereof are shown in Table 2.

### Example 24

A cured film and an antireflection film were formed in the same procedures as in Example 22 except that HOYA EYAS (a trade name, produced by HOYA Corporation, refractive index (ne): 1.60, hereinafter referred to as “lens substrate D”) was used as a lens substrate instead of the lens substrate B. The evaluation results of the properties thereof are shown in Table 2.

### Example 25

A cured film and an antireflection film were formed in the same procedures as in Example 22 except that HOYA Phoenix (a trade name, produced by HOYA Corporation, refractive index (ne): 1.53, hereinafter referred to as “lens substrate E”) was used as a lens substrate instead of the lens substrate B. The evaluation results of the properties thereof are shown in Table 2.

### Example 26

A cured film and an antireflection film were formed in the same procedures as in Example 22 except that HOYA Hi-Lux (a trade name, produced by HOYA Corporation, refractive index (ne): 1.50, hereinafter referred to as “lens substrate F”) was used as a lens substrate instead of the lens substrate B. The evaluation results of the properties thereof are shown in Table 2.

### Example 27

A coating composition was prepared in the same manner as in Example 22 except that 1.9 parts by mass of tetraethylenepentamine was used instead of 5.2 parts by mass of β-aminoethylaminopropyltriethoxysilane as the component (ii), and 13.1 parts by mass of γ-isocyanatopropyltriethoxysilane as the component (iii) and 17.2 parts by mass of 0.01 mol/L hydrochloric acid were used, and a cured film and an antireflection film were formed. The evaluation results of the properties thereof are shown in Table 2.

### Example 28

A cured film and an antireflection film were formed in the same procedures as in Example 27 except that the lens substrate A was used as a lens substrate instead of the lens substrate B. The evaluation results of the properties thereof are shown in Table 2.

### Example 29

A cured film and an antireflection film were formed in the same procedures as in Example 27 except that the lens substrate D was used as a lens substrate instead of the lens substrate B. The evaluation results of the properties thereof are shown in Table 2.

### Example 30

A cured film and an antireflection film were formed in the same procedures as in Example 27 except that the lens substrate E was used as a lens substrate instead of the lens substrate B. The evaluation results of the properties thereof are shown in Table 2.

### Example 31

A cured film and an antireflection film were formed in the same procedures as in Example 27 except that the lens substrate F was used as a lens substrate instead of the lens substrate B. The evaluation results of the properties thereof are shown in Table 2.

### Example 32

1.7 parts by mass of ethylene glycol as the component (ii) was added dropwise to 13.3 parts by mass of γ-isocyanatopropyltriethoxysilane as the component (iii) under stirring, followed by stirring for 1 hour, in an atmosphere at 40° C. 0.0075 part by mass of di-n-butyltin dilaurate as a curing agent was added to solution, followed by stirring for 24 hours. 50 parts by mass of diacetone alcohol (DAA) and 50 parts by mass of propylene glycol monomethyl ether (PGM) as a solvent were added thereto, and after setting the temperature to 5° C., 60.0 parts by mass of γ-glycidoxypropyltrimethoxysilane as the component (i) was then further mixed thereto. 17.3 parts by mass of 0.01 mol/L hydrochloric acid was added dropwise thereto under stirring, followed by stirring for 48 hours. According to the operation, a hydrolysate of an organosilicon compound was obtained.

187 parts by mass of a modified zirconium oxide-stannic oxide composite methanol sol as a sol component and 99.1 parts by mass of propylene glycol monomethyl ether (PGM) were mixed, followed by stirring for 1 hour, in an atmosphere at 5° C. Thereafter, the hydrolysate of an organosilicon compound prepared above was added dropwise thereto under stirring, followed by stirring for 1 hour. Subsequently, 0.25 part by mass of a silicone surfactant (Y-7006, a trade name, produced by Dow Corning Toray Co. , Ltd.) and 7.5 parts by mass of aluminum trisacetylacetylacetnate as a curing agent were added sequentially thereto, followed by stirring for 150 hours. The resulting solution was filtered with a 0.5-μm filter to provide a coating composition.

A cured film and an antireflection film were formed in the same procedures as in Example 22. The evaluation results of the properties thereof are shown in Table 2.

### Example 33

A cured film and an antireflection film were formed in the same procedures as in Example 32 except that the lens substrate A was used as a lens substrate instead of the lens substrate B. The evaluation results of the properties thereof are shown in Table 2.

### Example 34

A cured film and an antireflection film were formed in the same procedures as in Example 32 except that the lens substrate D was used as a lens substrate instead of the lens substrate B. The evaluation results of the properties thereof are shown in Table 2.

### Example 35

A cured film and an antireflection film were formed in the same procedures as in Example 32 except that the lens substrate E was used as a lens substrate instead of the lens substrate B. The evaluation results of the properties thereof are shown in Table 2.

### Example 36

A cured film and an antireflection film were formed in the same procedures as in Example 32 except that the lens substrate F was used as a lens substrate instead of the lens substrate B. The evaluation results of the properties thereof are shown in Table 2.

### Example 37

A coating composition was prepared in the same manner as in Example 32 except that 6.6 parts by mass of γ-mercaptopropyltrimethoxysilane was used instead of 1.7 parts by mass of ethylene glycol as the component (ii), and 8.4 parts by mass of γ-isocyanatopropyltriethoxysilane as the component (iii) and 18.1 parts by mass of 0.01 mol/L hydrochloric acid were used, and a cured film and an antireflection film were formed. The evaluation results of the properties thereof are shown in Table 2.

### Example 38

A cured film and an antireflection film were formed in the same procedures as in Example 37 except that the lens substrate A was used as a lens substrate instead of the lens substrate B. The evaluation results of the properties thereof are shown in Table 2.

### Example 39

A cured film and an antireflection film were formed in the same procedures as in Example 37 except that the lens substrate D was used as a lens substrate instead of the lens substrate B. The evaluation results of the properties thereof are shown in Table 2.

### Example 40

A cured film and an antireflection film were formed in the same procedures as in Example 37 except that the lens substrate E was used as a lens substrate instead of the lens substrate B. The evaluation results of the properties thereof are shown in Table 2.

### Example 41

A cured film and an antireflection film were formed in the same procedures as in Example 37 except that the lens substrate F was used as a lens substrate instead of the lens substrate B. The evaluation results of the properties thereof are shown in Table 2.

### Example 42

A coating composition was prepared in the same manner as in Example 32 except that 4.5 parts by mass of bismercaptomethyldithiane was used instead of 1.7 parts by mass of ethylene glycol as the component (ii), and 10.5 parts by mass of γ-isocyanatopropyltriethoxysilane as the component (iii) and 16.6 parts by mass of 0.01 mol/L hydrochloric acid were used, and a cured film and an antireflection film were formed. The evaluation results of the properties thereof are shown in Table 2.

### Example 43

A cured film and an antireflection film were formed in the same procedures as in Example 42 except that the lens substrate A was used as a lens substrate instead of the lens substrate B. The evaluation results of the properties thereof are shown in Table 2.

### Example 44

A cured film and an antireflection film were formed in the same procedures as in Example 42 except that the lens substrate D was used as a lens substrate instead of the lens substrate B. The evaluation results of the properties thereof are shown in Table 2.

### Example 45

A cured film and an antireflection film were formed in the same procedures as in Example 42 except that the lens substrate E was used as a lens substrate instead of the lens substrate B. The evaluation results of the properties thereof are shown in Table 2.

### Example 46

A cured film and an antireflection film were formed in the same procedures as in Example 42 except that the lens substrate F was used as a lens substrate instead of the lens substrate B. The evaluation results of the properties thereof are shown in Table 2.

### Example 47

A coating composition was prepared in the same manner as in Example 22 except that 10.9 parts by mass of γ-aminopropyltriethoxysilane was used instead of 5.2 parts by mass of β-aminoethylaminopropyltriethoxysilane as the component (ii), 4.13 parts by mass of hexamethylene diisocyanate was used instead of 9.8 parts by mass of γ-isocyanatopropyltriethoxysilane as the component (iii), and 18.7 parts by mass of 0.01 mol/L hydrochloric acid was used, and a cured film and an antireflection film were formed. The evaluation results of the properties thereof are shown in Table 2.

### Example 48

A cured film and an antireflection film were formed in the same procedures as in Example 47 except that the lens substrate A was used as a lens substrate instead of the lens substrate B. The evaluation results of the properties thereof are shown in Table 2.

### Example 49

A cured film and an antireflection film were formed in the same procedures as in Example 47 except that the lens substrate D was used as a lens substrate instead of the lens substrate B. The evaluation results of the properties thereof are shown in Table 2.

### Example 50

A cured film and an antireflection film were formed in the same procedures as in Example 47 except that the lens substrate E was used as a lens substrate instead of the lens substrate B. The evaluation results of the properties thereof are shown in Table 2.

### Example 51

A cured film and an antireflection film were formed in the same procedures as in Example 47 except that the lens substrate F was used as a lens substrate instead of the lens substrate B. The evaluation results of the properties thereof are shown in Table 2.

### Example 52

A coating composition was prepared in the same manner as in Example 32 except that 10.5 parts by mass of γ-mercaptopropyltrimethoxysilane was used instead of 1.7 parts by mass of ethylene glycol as the component (ii), 4.5 parts by mass of hexamethylene diisocyanate was used instead of 13.3 parts by mass of γ-isocyanatopropyltriethoxysilane as the component (iii), and 17.3 parts by mass of 0.01 mol/L hydrochloric acid was used, and a cured film and an antireflection film were formed. The evaluation results of the properties thereof are shown in Table 2.

### Example 53

A cured film and an antireflection film were formed in the same procedures as in Example 52 except that the lens substrate A was used as a lens substrate instead of the lens substrate B. The evaluation results of the properties thereof are shown in Table 2.

### Example 54

A cured film and an antireflection film were formed in the same procedures as in Example 52 except that the lens substrate D was used as a lens substrate instead of the lens substrate B. The evaluation results of the properties thereof are shown in Table 2.

### Example 55

A cured film and an antireflection film were formed in the same procedures as in Example 52 except that the lens substrate E was used as a lens substrate instead of the lens substrate B. The evaluation results of the properties thereof are shown in Table 2.

### Example 56

A cured film and an antireflection film were formed in the same procedures as in Example 52 except that the lens substrate F was used as a lens substrate instead of the lens substrate B. The evaluation results of the properties thereof are shown in Table 2.

### Example 57

A coating composition was prepared in the same manner as in Example 22 except that a modified titanium oxide-silicon oxide-zirconium oxide composite methanol sol (OPT LAKE 11302, a trade name, produced by JGC Catalysts and Chemicals Ltd.) was used instead of 187 parts by mass of the modified zirconium oxide-stannic oxide composite methanol sol, and a cured film and an antireflection film were formed. The evaluation results of the properties thereof are shown in Table 2.

### Example 58

A cured film and an antireflection film were formed in the same procedures as in Example 57 except that the lens substrate A was used as a lens substrate instead of the lens substrate B. The evaluation results of the properties thereof are shown in Table 2.

### Example 59

A cured film and an antireflection film were formed in the same procedures as in Example 57 except that the lens substrate D was used as a lens substrate instead of the lens substrate B. The evaluation results of the properties thereof are shown in Table 2.

### Example 60

A cured film and an antireflection film were formed in the same procedures as in Example 57 except that the lens substrate E was used as a lens substrate instead of the lens substrate B. The evaluation results of the properties thereof are shown in Table 2.

### Example 61

A cured film and an antireflection film were formed in the same procedures as in Example 57 except that the lens substrate F was used as a lens substrate instead of the lens substrate B. The evaluation results of the properties thereof are shown in Table 2.

### Comparative Example 9

A coating composition was prepared in the same manner as in Example 22 except that β-aminoethylaminopropyltriethoxysilane and γ-isocyanatopropyltriethoxysilane were not used, but 75 parts by mass of γ-glycidoxypropyltrimethoxysilane was used as a silane coupling agent, and a cured film and an antireflection film were formed. The evaluation results of the properties thereof are shown in Table 2.

### Comparative Example 10

A cured film and an antireflection film were formed in the same procedures as in Comparative Example 9 except that the lens substrate A was used as a lens substrate instead of the lens substrate B. The evaluation results of the properties thereof are shown in Table 2.

### Comparative Example 11

A coating composition was prepared in the same manner as in Example 22 except that β-aminoethylaminopropyltriethoxysilane was not used, but 15 parts by mass of γ-isocyanatopropyltriethoxysilane and 60 parts by mass of γ-glycidoxypropyltrimethoxysilane were used as a silane coupling agent, and a cured film and an antireflection film were formed. The evaluation results of the properties thereof are shown in Table 2.

### Comparative Example 12

A cured film and an antireflection film were formed in the same procedures as in Comparative Example 11 except that the lens substrate A was used as a lens substrate instead of the lens substrate B. The evaluation results of the properties thereof are shown in Table 2.

### Comparative Example 13

A coating composition was prepared in the same manner as in Example 22 except that 7-isocyanatopropyltriethoxysilane was not used, but 1 part by mass of β-aminoethylaminopropyltriethoxysilane and 74 parts by mass of γ-glycidoxypropyltrimethoxysilane were used as a silane coupling agent, and a cured film and an antireflection film were formed. The evaluation results of the properties thereof are shown in Table 2.

### Comparative Example 14

A cured film and an antireflection film were formed in the same procedures as in Comparative Example 13 except that the lens substrate A was used as a lens substrate instead of the lens substrate B. The evaluation results of the properties thereof are shown in Table 2.

### Comparative Example 15

A coating composition was prepared in the same manner as in Example 22 except that γ-glycidoxypropyltrimethoxysilane was not used, but 26.1 parts by mass of β-aminoethylaminopropyltriethoxysilane and 48.9 parts by mass of γ-isocyanatopropyltriethoxysilane were used as a silane coupling agent, and a cured film and an antireflection film were formed. The evaluation results of the properties thereof are shown in Table 2.

### Comparative Example 16

A cured film and an antireflection film were formed in the same procedures as in Comparative Example 15 except that the lens substrate A was used as a lens substrate instead of the lens substrate B. The evaluation results of the properties thereof are shown in Table 2.

TABLE 2

| | | Adhesion | | Abrasion resistance | | Bayer value | | Transparency | | Crack |
|---|---|---|---|---|---|---|---|---|---|---|
| | Sub- | Cured | Antireflection | Cured | Antireflection | Cured | Antireflection | Cured | Antireflection | Cured |
| | strate | film | film | film | film | film | film | film | film | film |
| Example 22 | B | AA | AA | AA | AA | 3 | 12 | AA | AA | AA |
| Example 23 | A | AA | AA | AA | AA | 3 | 12 | AA | AA | AA |
| Example 24 | D | AA | AA | AA | AA | 3 | 12 | AA | AA | AA |
| Example 25 | E | AA | AA | AA | AA | 3 | 12 | AA | AA | AA |
| Example 26 | F | AA | AA | AA | AA | 3 | 12 | AA | AA | AA |
| Example 27 | B | AA | AA | AA | AA | 3 | 12 | AA | AA | AA |
| Example 28 | A | AA | AA | AA | AA | 3 | 12 | AA | AA | AA |
| Example 29 | D | AA | AA | AA | AA | 3 | 12 | AA | AA | AA |
| Example 30 | E | AA | AA | AA | AA | 3 | 12 | AA | AA | AA |
| Example 31 | F | AA | AA | AA | AA | 3 | 12 | AA | AA | AA |
| Example 32 | B | AA | AA | AA | AA | 3 | 12 | AA | AA | AA |
| Example 33 | A | AA | AA | AA | AA | 3 | 12 | AA | AA | AA |
| Example 34 | D | AA | AA | AA | AA | 3 | 12 | AA | AA | AA |
| Example 35 | E | AA | AA | AA | AA | 3 | 12 | AA | AA | AA |
| Example 36 | F | AA | AA | AA | AA | 3 | 12 | AA | AA | AA |
| Example 37 | B | AA | AA | AA | AA | 3 | 12 | AA | AA | AA |
| Example 38 | A | AA | AA | AA | AA | 3 | 12 | AA | AA | AA |
| Example 39 | D | AA | AA | AA | AA | 3 | 12 | AA | AA | AA |
| Example 40 | E | AA | AA | AA | AA | 3 | 12 | AA | AA | AA |
| Example 41 | F | AA | AA | AA | AA | 3 | 12 | AA | AA | AA |
| Example 42 | B | AA | AA | AA | AA | 3 | 12 | AA | AA | AA |
| Example 43 | A | AA | AA | AA | AA | 3 | 12 | AA | AA | AA |
| Example 44 | D | AA | AA | AA | AA | 3 | 12 | AA | AA | AA |
| Example 45 | E | AA | AA | AA | AA | 3 | 12 | AA | AA | AA |
| Example 46 | F | AA | AA | AA | AA | 3 | 12 | AA | AA | AA |
| Example 47 | B | AA | AA | AA | AA | 3 | 12 | AA | AA | AA |
| Example 48 | A | AA | AA | AA | AA | 3 | 12 | AA | AA | AA |
| Example 49 | D | AA | AA | AA | AA | 3 | 12 | AA | AA | AA |
| Example 50 | E | AA | AA | AA | AA | 3 | 12 | AA | AA | AA |
| Example 51 | F | AA | AA | AA | AA | 3 | 12 | AA | AA | AA |
| Example 52 | B | AA | AA | AA | AA | 3 | 12 | AA | AA | AA |
| Example 53 | A | AA | AA | AA | AA | 3 | 12 | AA | AA | AA |
| Example 54 | D | AA | AA | AA | AA | 3 | 12 | AA | AA | AA |
| Exemple 55 | E | AA | AA | AA | AA | 3 | 12 | AA | AA | AA |
| Example 56 | F | AA | AA | AA | AA | 3 | 12 | AA | AA | AA |
| Example 57 | B | AA | AA | AA | AA | 3 | 12 | AA | AA | AA |
| Example 58 | A | AA | AA | AA | AA | 3 | 12 | AA | AA | AA |
| Example 59 | D | AA | AA | AA | AA | 3 | 12 | AA | AA | AA |
| Example 60 | E | AA | AA | AA | AA | 3 | 12 | AA | AA | AA |
| Example 61 | F | AA | AA | AA | AA | 3 | 12 | AA | AA | AA |
| Comparative | B | C | C | AA | AA | 3 | 12 | AA | AA | C |
| Example 9 | | | | | | | | | | |
| Comparative | A | C | C | AA | AA | 3 | 12 | AA | AA | C |
| Example 10 | | | | | | | | | | |
| Comparative | B | B | B | A | A | 2.5 | 10 | B | B | AA |
| Example 11 | | | | | | | | | | |
| Comparative | A | B | B | A | A | 2.5 | 10 | B | B | AA |
| Example 12 | | | | | | | | | | |
| Comparative | B | B | B | A | A | 2.5 | 10 | B | B | AA |
| Example 13 | | | | | | | | | | |
| Comparative | A | B | B | A | A | 2.5 | 10 | B | B | AA |
| Example 14 | | | | | | | | | | |
| Comparative | B | AA | AA | B | B | 1.5 | 6 | AA | AA | AA |
| Example 15 | | | | | | | | | | |
| Comparative | A | AA | AA | B | B | 1.5 | 6 | AA | AA | AA |
| Example 16 | | | | | | | | | | |

### INDUSTRIAL APPLICABILITY

The plastic lens of the present invention is excellent in abrasion resistance, transparency and appearance, and in particular, excellent in adhesion to a cured film, with a lens containing a resin having an NHCO structure represented by the formula (A) or a resin having a unit derived from a compound represented by the formula (B) used as a substrate.

1. A plastic lens comprising, as a substrate, a lens comprising a resin having an NHCO structure represented by the following formula (A) or a resin having a unit derived from a compound represented by the following formula (B), and a cured film having an NHCO structure formed by reacting a coating composition containing the following components (i), (ii) and (iii) directly on the substrate: 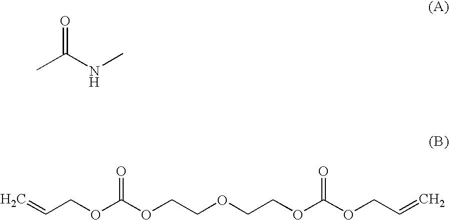
component (i):
at least one selected from an organosilicon compound represented by the following general formula (1), an organosilicon compound represented by the following general formula (2) and a hydrolysate of the organosilicon compounds:
R¹ₙSi(OR²)₄₋ₙ (1)
(in the formula, R¹ represents a monovalent hydrocarbon group having from 3 to 20 carbon atoms and having a functional group (a vinyl group, an epoxy group, a styryl group, a methacryl group or an acrylic group); R² represents an alkyl group having from 1 to 8 carbon atoms, an aryl group having from 6 to 10 carbon atoms, an aralkyl group having from 7 to 10 carbon atoms or an acyl group having from 2 to 10 carbon atoms; and n represents an integer of 1 or 2, in which when plural R¹ groups are present, the plural R¹ groups may be the same or different, and plural OR² groups may be the same or different) 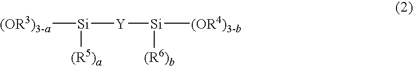
(in the formula, R³ and R⁴ each represent an alkyl group having from 1 to 4 carbon atoms or an acyl group having from 2 to 4 carbon atoms, and may be the same or different; R⁵ and R⁶ each represent a monovalent hydrocarbon group having from 1 to 5 carbon atoms and having or not having a functional group, and may be the same or different; Y represents a divalent hydrocarbon group having from 2 to 20 carbon atoms; and a and b each represent an integer of 0 or 1, in which plural OR³ groups may be the same or different, and plural OR⁴ groups may be the same or different),
component (ii):
at least one selected from an amino group-containing organic compound, a hydroxyl group-containing organic compound, a mercapto group-containing organic compound, an amino group-containing organosilicon compound, a hydroxyl group-containing organosilicon compound and a mercapto group-containing organosilicon compound,
component (iii):
at least one selected from an isocyanate group-containing organic compound and an isocyanate group-containing organosilicon compound.

2. The plastic lens as claimed in claim 1, wherein the component (ii) is at least one selected from an amino group-containing organosilicon compound represented by the following general formula (3) and a hydrolysate thereof:
R⁷ₙSi(OR⁸)₄₋ₙ (3)
(in the formula, R⁷ represents a monovalent amino group-containing hydrocarbon group having from 1 to 20 carbon atoms; R⁸ represents an alkyl group having from 1 to 8 carbon atoms, an aryl group having from 6 to 10 carbon atoms, an aralkyl group having from 7 to 10 carbon atoms or an acyl group having from 2 to 10 carbon atoms; and n represents an integer of 1 or 2, in which when plural R⁷ groups are present, the plural R⁷ groups may be the same or different, and plural OR⁸ groups may be the same or different.

3. The plastic lens as claimed in claim 1 or 2, wherein the component (iii) is at least one selected from an isocyanate group-containing organosilicon compound represented by the following general formula (4) and a hydrolysate thereof:
R⁹ₙSi(OR¹)₄₋ₙ (4)
(in the formula, R⁹ represents a monovalent isocyanate group-containing hydrocarbon group having from 1 to 20 carbon atoms; R¹⁰ represents an alkyl group having from 1 to 8 carbon atoms, an aryl group having from 6 to 10 carbon atoms, an aralkyl group having from 7 to 10 carbon atoms or an acyl group having from 2 to 10 carbon atoms; and n represents an integer of 1 or 2, in which when plural R⁹ groups are present, the plural R⁹ groups may be the same or different, and plural OR¹⁰ groups may be the same or different.

4. The plastic lens as claimed in claim 1, wherein the organosilicon compound represented by the general formula (1) as the component (i) is a γ-glycidoxypropyltrialkoxysilane.

5. The plastic lens as claimed in claim 2, wherein the organosilicon compound represented by the general formula (3) as the component (ii) is a γ-aminopropyltrialkoxysilane.

6. The plastic lens as claimed in claim 3, wherein the organosilicon compound represented by the general formula (4) as the component (iii) is a γ-isocyanatopropyltrialkoxysilane.

7. The plastic lens as claimed in claim 1, wherein a molar ratio of functional groups in the components (i), (ii) and (iii) is from 99/0.5/0/5 to 10/45/45 in the coating composition.

8. The plastic lens as claimed in claim 1, wherein the coating composition contains a metallic oxide in a fine particle form.

9. The plastic lens as claimed in claim 1, wherein the coating composition contains modified zirconium oxide-stannic oxide complex colloid particles (C) that contains zirconium oxide-stannic oxide complex colloid particles (A2) having a structure containing colloid particles of zirconium oxide and colloid particles of stannic oxide bonded at a ratio of from 0.02 to 0.4 in terms of SnO₂/ZnO₂ based on the molar ratio of the oxides, having a particle diameter of from 2.5 to 100 nm, and containing amine-containing Sb₂O₅, as a core, having coated on the surface thereof colloid particles (B2) of a tungsten oxide-stannic oxide-silicon dioxide complex having a mass ratio WO₃/SnO₂ of from 0.1 to 100, a mass ratio SiO₂/SnO₂ of from 0.1 to 100 and a particle diameter of from 2 to 7 nm, with a mass ratio (B2)/(A2) being from 0.02 to 1 based on the mass ratio of the metal oxides thereof, and that has a particle diameter of from 2.5 to 100 nm.

10. The plastic lens as claimed in claim 1, wherein the component (ii) and the component (iii) are reacted with each other, and then the component (i) is added thereto and reacted therewith.

11. The plastic lens as claimed in claim 1, wherein the substrate contains a polythiourethane lens obtained by reacting xylylene diisocyanate and polythiol, or a sulfur-containing lens obtained by reacting a lens raw material monomer containing a compound having an epithio group.

12. The plastic lens as claimed in claim 11, wherein in the sulfur-containing lens, the compound having an epithio group is bis(β-epithiopropyl)sulfide and/or bis(β-epithiopropyl)disulfide.

13. The plastic lens as claimed in claim 11, wherein in the sulfur-containing lens, an amount of the compound having an epithio group is from 60 to 90% by weight based on a total amount of the lens raw material monomers.

14. The plastic lens as claimed in claim 11, wherein the polythiourethane lens has a refractive index of from 1.65 to 1.69, and is obtained by reacting xylylene diisocyanate and polythiol, and mercaptomethyldithiaoctanedithiol and/or bis(mercaptomethyl)trithiaundecanedithiol are used as a component of the polythiol.

15. The plastic lens as claimed in claim 1, wherein the polythiourethane lens has a refractive index of from 1.65 to 1.69 and/or the sulfur-containing lens has a refractive index of from 1.69 to 1.72.

16. The plastic lens as claimed in claim 11, wherein the polythiourethane lens has a refractive index of from 1.65 to 1.69.
